(19) United States
(12) Patent Application Publication
(10) Pub. No.: US 2001/0043381 A1
(43) Pub. Date: Nov. 22, 2001

(54) Optical free space signalling system

(76) Inventors: Alan E. Green, Ickleton (GB); Euan Morrison, Ickleton (GB)

Correspondence Address: NIXON & VANDERHYE P.C., 8th Floor, 1100 North Glebe Road, Arlington, VA, 22201-4714, US

(21) Appl. No.: 09/892,511

(22) Filed: Jun. 28, 2001

Related U.S. Application Data
(63) Continuation of application No. PCT/GB00/00456, filed on Feb. 11, 2000.

(30) Foreign Application Priority Data
Feb. 11, 1999 (GB) 9903142.9
Jul. 13, 1999 (GB) 9916422.0

(51) Int. Cl. H04J 14/02; H04B 10/00

(52) U.S. Cl. 359/172; 359/131

(57) ABSTRACT

A signalling system is provided which comprises first and second signalling devices. The first signalling device comprises (i) a plurality of light emitters each for emitting a respective light beam carrying information; and (ii) a lens system for collecting light emitted from the plurality of light emitters and for directing the light beams in respective directions within the field of view of the lens system. The second signalling device comprises (i) a lens system for collecting light emitted from a light emitter of the first signalling device; (ii) a light detector for receiving the collected light from the lens system and for converting the received light into corresponding electrical signals; and (iii) means for processing the electrical signals from the light detector to retrieve the information.

The present invention relates to a signalling system. One aspect of the present invention relates to an optical free space signalling method and apparatus.

Free space point-to-point transmission and point-to-multipoint transmission or broadcasting of communications has traditionally been achieved using radio or microwave techniques. These frequencies, however, are limited with respect to bandwidth and cannot achieve the desired performance. Also there are situations when the regulatory requirements for a radio system cannot be met. Further, often the regulations vary from country to country and hence it is difficult to manufacture a global product.

Optical data transmission can achieve very high bandwidth (several gigabits per second per carrier) but its use to date has been limited mainly to guided wave transmission through optical fibres. The applicant has proposed in their earlier International application WO98/35328 a point-to-multipoint data transmission system which uses a retroreflector to receive collimated laser beams from a plurality of user terminals, to modulate the received laser beams and to reflect them back to the respective user terminals. One of the problems with the retro-reflecting system described in this earlier International application is that the laser light must travel twice the distance between the modulation side of the communication system and the user terminal. Another disadvantage of the system described in this earlier International application is that each of the sources must be accurately aligned with a respective modulator cell within the retroreflector to achieve successful communications and movement of the user terminal can break the communications link with the modulation side.

According to one aspect, the present invention provides a signalling system comprising first and second signalling devices in which the first signalling device comprises a plurality of light emitters which are arranged to emit light in a respective direction within the field of view of the first signalling device and in which the second signalling device comprises a light detector for detecting light emitted by the first signalling device and means for retrieving the information from the detected light.

In a preferred form of this aspect, the signalling system comprises first and second signalling devices, the first signalling device comprising: (i) a plurality of light emitters each for emitting a respective light beam carrying information; and (ii) a lens system for collecting light emitted from the plurality of light emitters and for directing the light beams in a respective direction within the field of view of the lens system; and the second signalling device comprising: (i) a lens system for collecting light emitted from a light emitter of the first signalling device; (ii) a light detector for receiving the collected light and for converting the received light into corresponding electrical signals; and (iii) processing circuitry for processing the electrical signals from the light detector to retrieve the information.

This system provides the advantage over the prior art that accurate alignment between the two signalling devices is not essential since a different emitter of the first signalling device can be used in the communications link. Preferably the link between the two signalling devices is a duplex link with each end of the link comprising an array of emitters and an array of detectors, since such an arrangement allows each signalling device to track the location of the other and to select a different emitter and detector pair used for the communications link between the two devices.

According to another aspect, the present invention also provides a signalling system comprising first and second signalling devices, with the first signalling device comprising a plurality of light emitters for emitting light in a respective direction within the field of view of the first signalling device, a light detector for detecting modulated light reflected back from the second signalling device and for converting the received light into corresponding electrical signals and processing circuitry for processing the electrical signals to retrieve the modulation data; and in which the second signalling device comprises a light reflector for reflecting light received from the first signalling device back to the first signalling device and a modulator for modulating the received light and/or the reflected light with modulation data for the first signalling device. Such a system provides the advantage that accurate alignment between the first and second signalling devices is not required to be able to establish a communications link, since the direction of the light emitted by the first signalling device can be changed by simply changing the light beam used to emit the light.

Exemplary embodiments of the present invention will now be described with reference to the accompanying drawings in which:

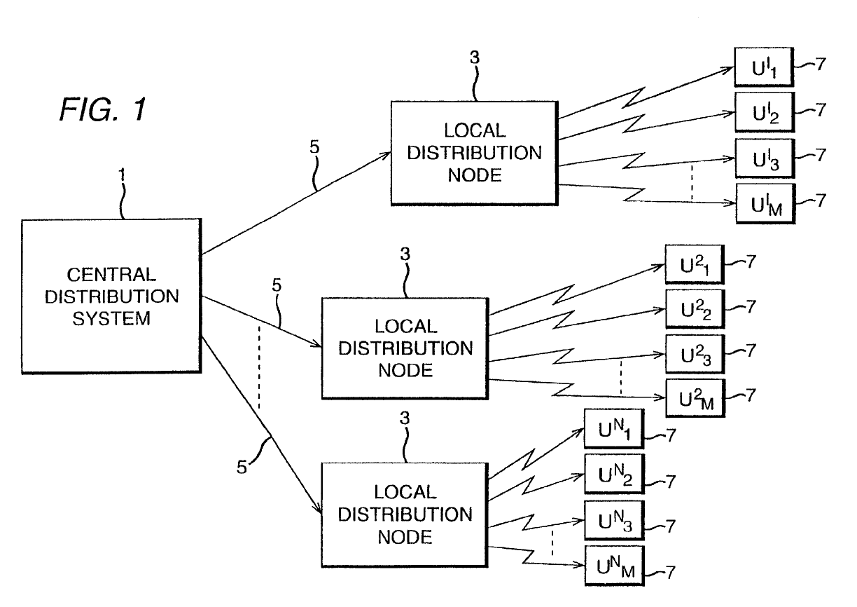

FIG. 1 is a schematic diagram of a data distribution system;

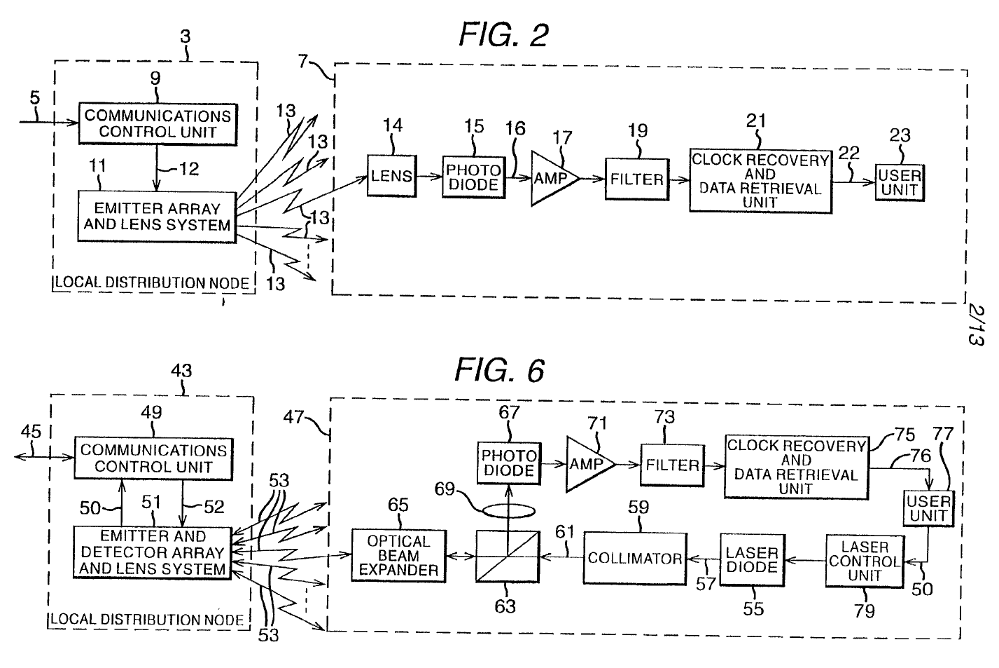

FIG. 2 is a schematic block diagram of a local distribution node and a user terminal which forms part of the data distribution system shown in FIG. 1;

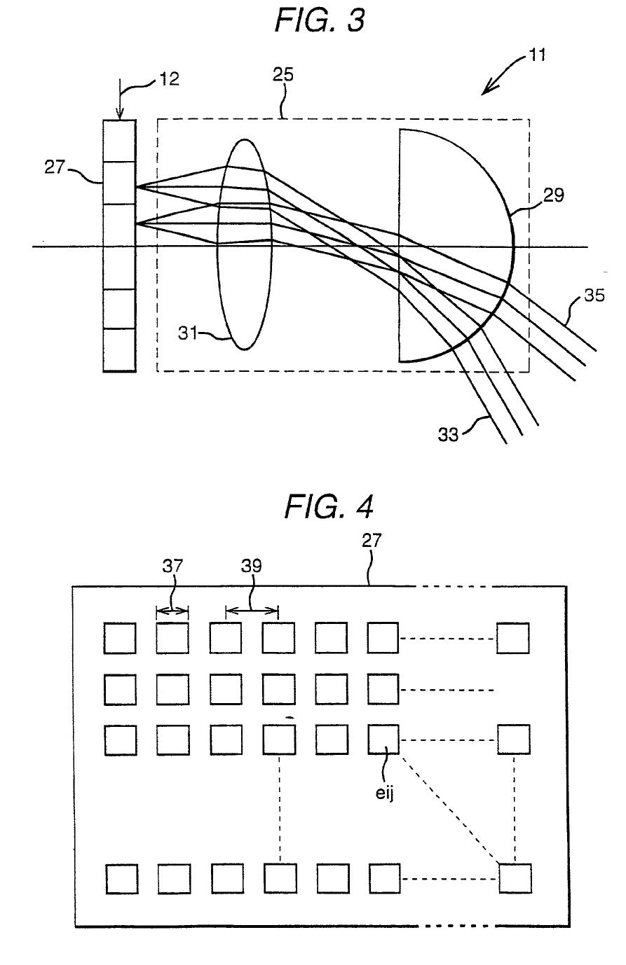

FIG. 3 is a schematic diagram of an emitter array and lens system employed in the local distribution node shown in FIG. 2;

FIG. 4 is a schematic diagram of a pixellated emitter array which forms part of the system shown in FIG. 3;

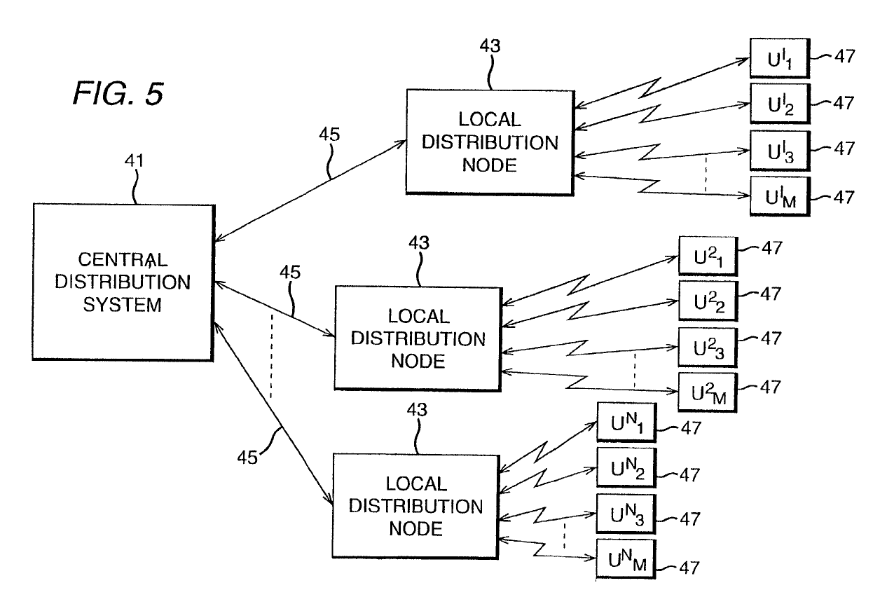

FIG. 5 is a schematic block diagram of a video data point to multipoint communication system;

FIG. 6 is a schematic block diagram of a local distribution node and a user terminal which forms part of the video data communication system shown in FIG. 5;

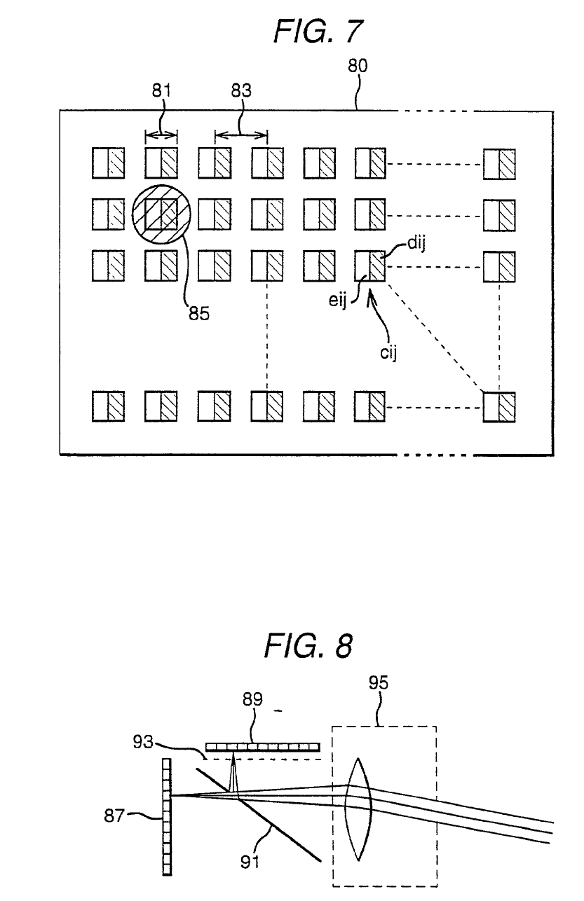

FIG. 7 is a schematic diagram of a pixellated emitter and detector array which is employed in the local distribution node shown in FIG. 6;

FIG. 8 is a schematic diagram of an alternative form of an emitter and detector array which can be used in the local distribution node shown in FIG. 6;

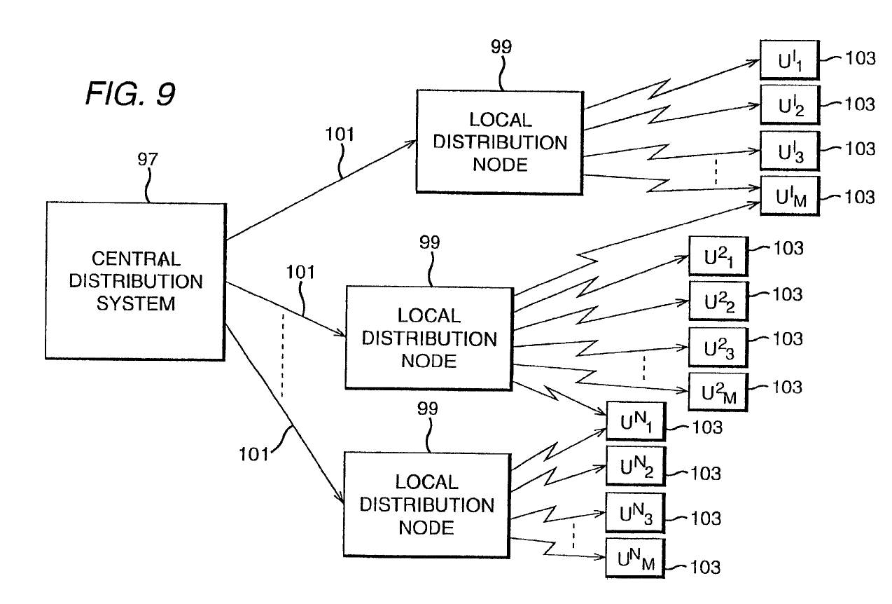

FIG. 9 is a schematic diagram of a multipoint to point data distribution system;

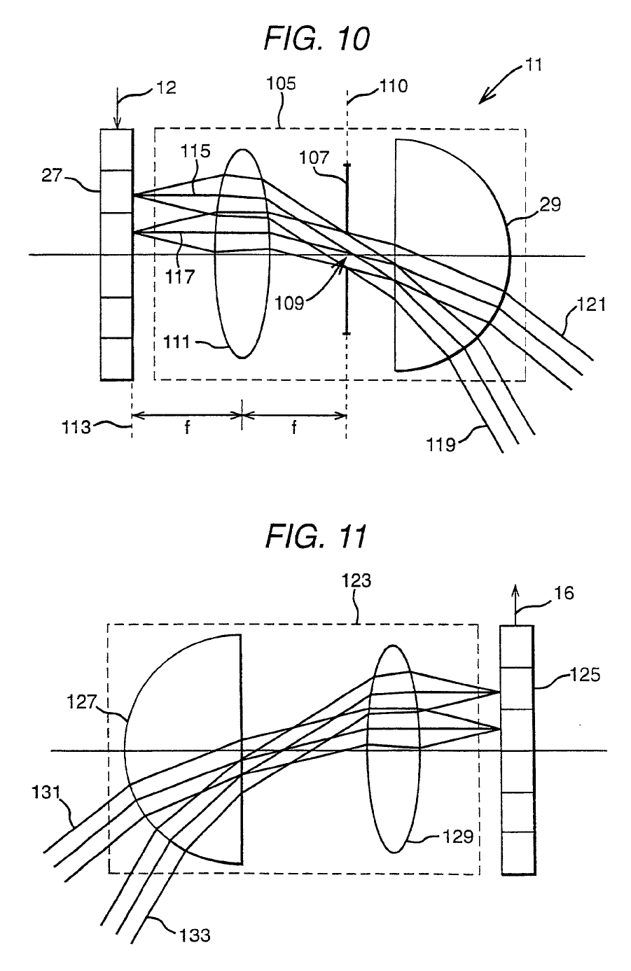

FIG. 10 is a schematic diagram of an emitter array and telecentric lens system employed in a local distribution node which forms part of the distribution system shown in FIG. 9;

FIG. 11 is a schematic diagram of a detector array and lens system employed in a user terminal which forms part of the distribution system shown in FIG. 9;

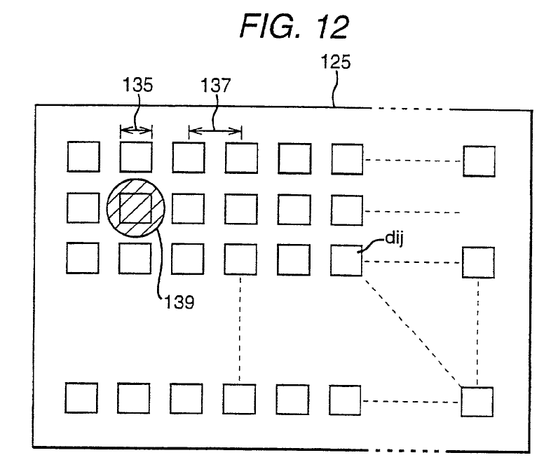

FIG. 12 is a schematic diagram of a pixellated detector array which forms part of the system shown in FIG. 11;

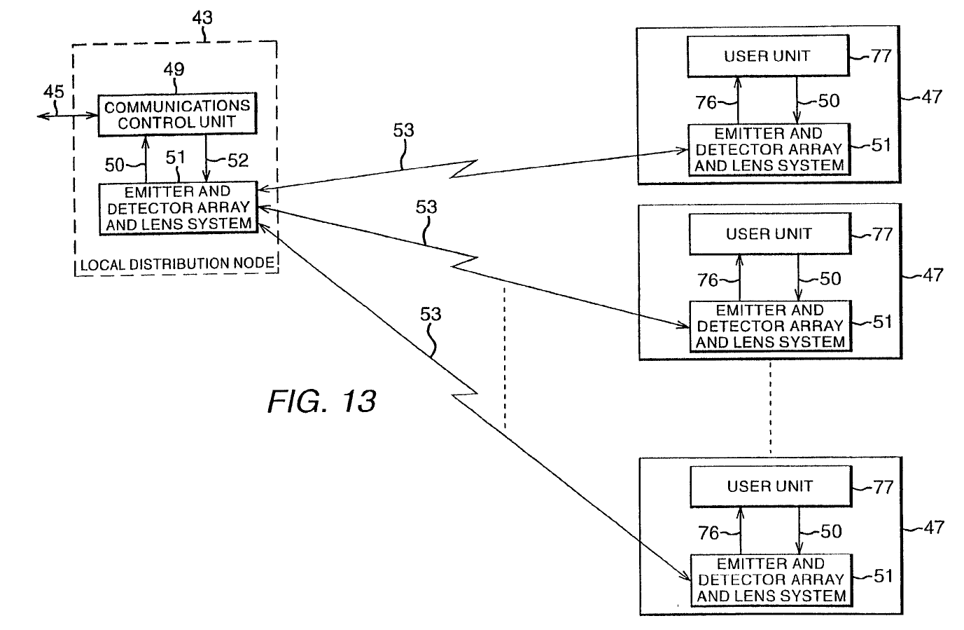

FIG. 13 is a schematic block diagram illustrating the form of an alternative local distribution node and user terminals which can be used in the video data communication system shown in FIG. 5;

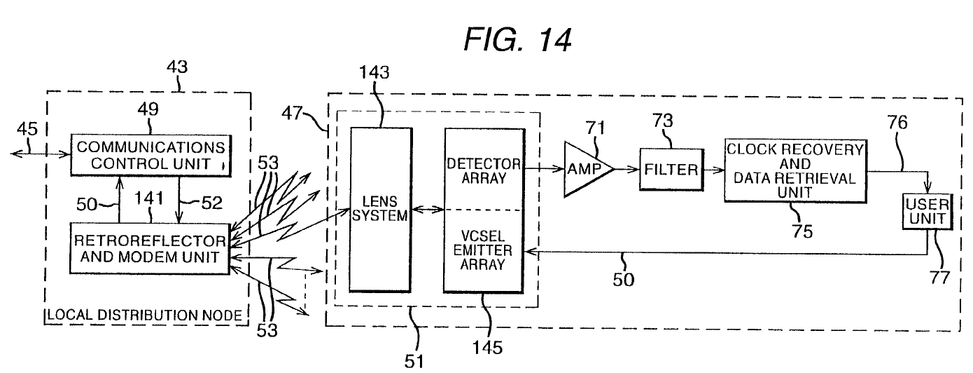

FIG. 14 is a schematic block diagram illustrating the form of an alternative local distribution node and a user terminal which can be used in the video data communication system shown in FIG. 5;

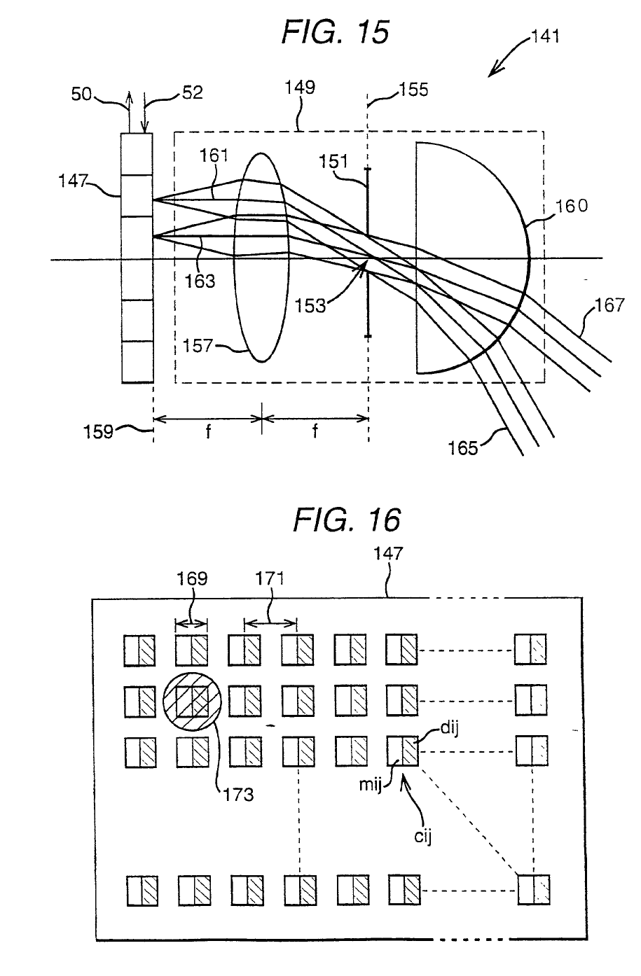

FIG. 15 is a schematic diagram of a retro-reflecting modulator unit employed in the local distribution node shown in FIG. 14;

FIG. 16 is a schematic diagram of a pixellated modulator forming part of the retro reflecting modulator unit shown in FIG. 15;

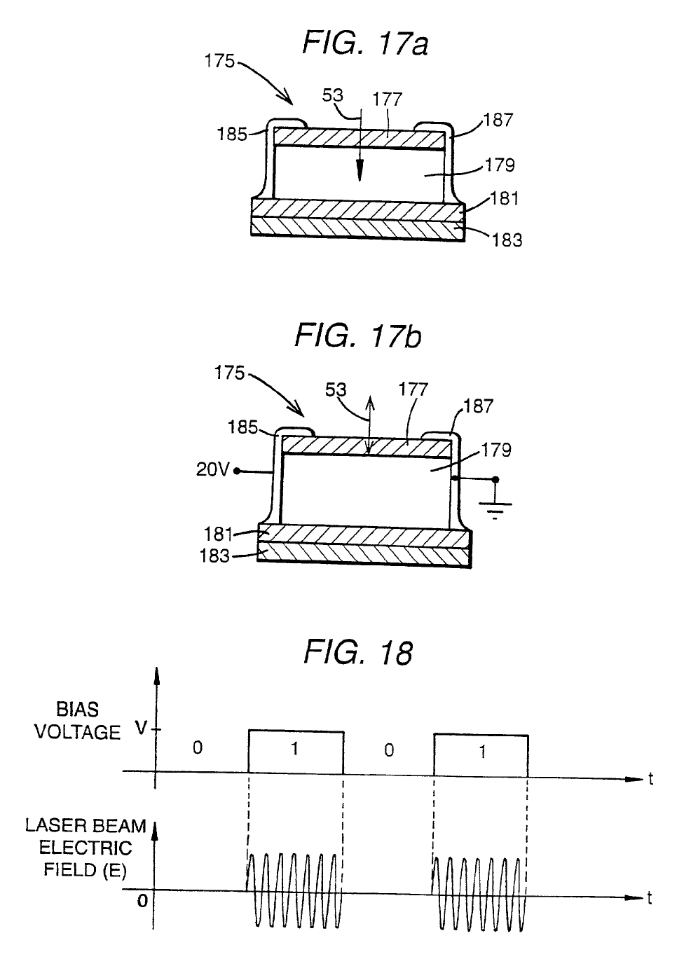

FIG. 17a is a cross-sectional view of one modulator of the pixellated modulator shown in FIG. 16 in a first operational mode when no DC bias is applied to electrodes thereof;

FIG. 17b is a cross-sectional view of one modulator of the pixellated modulator shown in FIG. 16 in a second operational mode when a bias voltage is applied to the electrodes;

FIG. 18 is a signal diagram which illustrates the way in which the light incident on a pixel of one of the modulators shown in FIG. 16 is modulated in dependence upon the bias voltage applied to the pixel electrodes; and

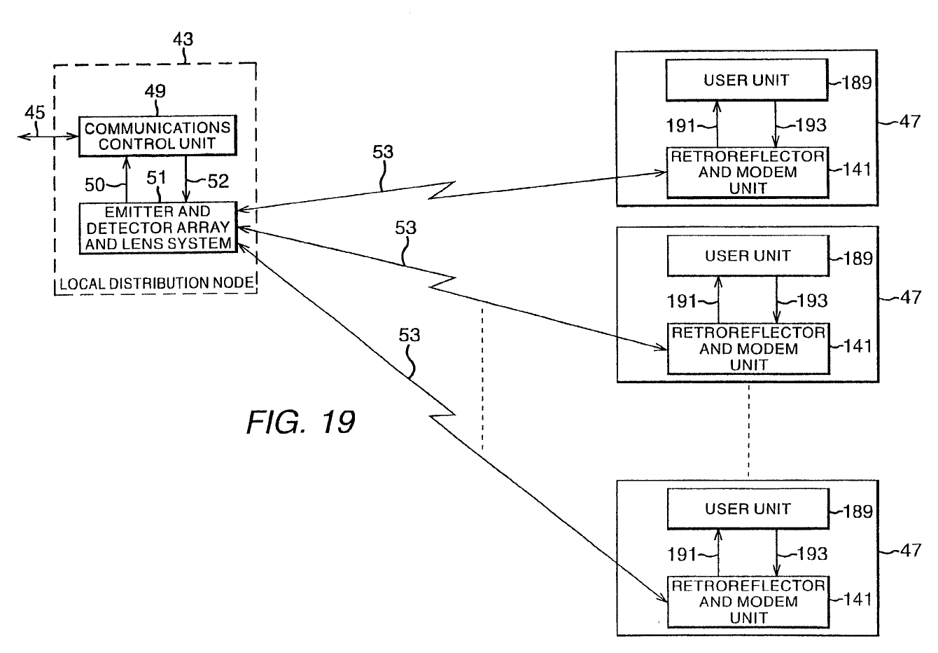

FIG. 19 is a schematic block diagram illustrating the form of an alternative local distribution node and user terminals which can be used in the video data communication system shown in FIG. 5.

FIG. 1 schematically illustrates a data distribution system which employs a point to multipoint signalling system for supplying data signals to a plurality of remote users. As shown in FIG. 1, the system comprises a central distribution system 1 which transmits optical data signals to a plurality of local distribution nodes 3 via optical fibres 5. The local distribution nodes 3 are arranged to receive the optical data signals transmitted from the central distribution system 1 and to transmit relevant parts of the data signals to respective user terminals 7 as optical signals through free space, i.e. not as optical signals along an optical fibre path. This kind of simplex data distribution system can be employed to distribute high bandwidth video data or low bandwidth data such as the prices of shares that are bought and sold on a stock market. In such applications, the user terminals 7 would comprise a display unit for displaying the video data or new prices of the stocks to the traders so that they can be kept up to date with changes in the share prices.

FIG. 2 schematically illustrates in more detail the main components of one of the local distribution nodes 3 and one of the user terminals 7 of the system shown in FIG. 1. As shown, the local distribution node 3 comprises a communications control unit 9 which is operable to receive the optical data transmitted by the central distribution system 1 via the optical fibres 5. The local distribution node 3 also comprises an emitter array and lens system 11 which is arranged to receive data 12 from the communications control unit 9 and to transmit the received data (in the form of modulated optical beams 13) to the user terminals 7.

FIG. 2 also shows the main components of one of the user terminals 7. As shown, the user terminal 7 comprises a lens 14 for focussing the received optical beam 13 onto a photo diode 15. The electrical signals 16 output by the photo diode 15, which will vary in dependence upon the data carried by the optical beam 13, are then amplified by the amplifier 17 and filtered by the filter 19. The filtered signals are then supplied to a clock recovery and data retrieval unit 21 which regenerates the clock and the original data using standard data processing techniques. The retrieved data 22 is then passed to the user unit 23, which, in this embodiment, comprises a display on which the data is displayed to the user. The structure and function of the components in the user terminal 7 are well known to those skilled in the art and therefore, a more detailed description of them shall be omitted.

FIG. 3 schematically illustrates the emitter array and lens system 11 which forms part of the local distribution node 3 shown in FIG. 2. In this embodiment, the emitter array 27 comprises an array of vertical cavity surface emitting lasers (hereinafter referred to as VCSELs). The use of a VCSEL array is preferred because the array can be manufactured from a single semiconductor wafer, without having to cut the wafer. This allows a higher density of lasing elements per square inch than would be the case with an array made from traditional laser diodes. These VCSEL arrays, manufactured and sold by CSEM SA (Badenerstrasse 569, 8048 Zurich, Switzerland), operate in a power range of between 1 and 30 mW and output a laser beam having a wavelength the same as conventional laser diodes. FIG. 4 is a schematic representation of the front surface (i.e. the emitting surface facing the lens system 25) of the emitter array 27 which, in this embodiment, comprises 8 columns and 8 rows of VCSEL elements, eᵢⱼ, (not all of which are shown in the figure). In this embodiment, the size 37 of each VCSEL element eᵢⱼ is between 1 and 20 micrometers, with the spacing (centre to centre) 39 between the elements being slightly greater than the cell size 37 and being of the order of 30-100 micrometers.

In this embodiment, the VCSEL emitters eᵢⱼ in the emitter array 27 are selectively addressable and the data 12 from the communications control unit includes respective data for each VCSEL emitter eᵢⱼ. The data for each VCSEL emitter may be the same or it may be different, depending on the application. As shown in FIG. 3, the light output by each emitter eᵢⱼ in the array 27 is a diverging beam, the divergence being primarily caused by diffraction at the emitting aperture of the laser. The lens system 25 collects the diverging beam from each emitter and forms it into a collected beam. As those skilled in the art will appreciate, and as illustrated by the light rays 33 and 35, the angle at which the collected beam leaves the exit pupil of the lens depends on the spatial position of the emitter in the array. Therefore, each emitter maps to a particular angle in space and can therefore communicate with a respective user terminal 7. In this embodiment, the lens system 25 is arranged so that the laser beams output by the lens system have sufficient divergence so that the edges of the laser beams overlap at a distance from the local distribution node which corresponds to the normal operating distance between the node and the user terminals. By arranging for the laser beams to overlap in this manner, the system avoids “dead areas” within the local distribution node's field of view in which signals from the node cannot be received. As those skilled in the art will appreciate, there will be some embodiments in which the maximum operating distance is the most important system consideration and in which it is not important if there are such “dead areas”. In such embodiments, the lens system 25 is preferably a collimating lens which collimates the light emitted by the VCSEL emitters as this maximises the operating distance.

A simplex (one way) data distribution system was described above. FIG. 5 schematically illustrates a duplex (two way) video broadcast system for supplying video signals, for a plurality of television channels to a plurality of remote users. As shown in FIG. 5, the system comprises a central distribution system 41 which transmits optical video signals to a plurality of local distribution nodes 43 via optical fibres 45. The local distribution nodes 43 are arranged to receive the optical video signals transmitted from the central distribution system 41 and to transmit relevant parts of the video signals to respective user terminals 47 as optical signals through free space.

In this embodiment, the video data for all the available television channels is transmitted from the central distribution system 41 to each of the local distribution nodes 43. Each user terminal 47 informs the appropriate local distribution node 43 which channel or channels it wishes to receive (by transmitting an appropriate request) and, in response, the local distribution node 43 transmits the appropriate video data, to the respective user terminals 47. To do this, each local distribution node 43 is arranged (i) to receive an optical beam (modulated with the user's channel request) transmitted from each of the user terminals 47 which are in its field of view; (ii) to act upon the received beams by selecting the appropriate video data for the desired channel or channels; and (iii) to transmit the appropriate video data for the desired channel or channels back to the respective user terminals 47. In addition to being able to receive optical signals from the central distribution system 41 and from the user terminals 47, each of the local distribution nodes 43 can also transmit optical data such as status reports, back to the central distribution system 41 via the respective optical fibre 45, so that the central distribution system 41 can monitor the status of the distribution network.

FIG. 6 schematically illustrates in more detail the main components of one of the local distribution nodes 43 and one of the user terminals 47 of the system shown in FIG. 5. As shown in FIG. 6, the local distribution node 43 comprises a communications control unit 49 which (i) receives the optical signals transmitted along the optical fibre 45 from the central distribution system 41; (ii) regenerates the video data from the received optical signals; (iii) receives messages 50 transmitted from the user terminals 47 and takes appropriate action in response thereto; and (iv) converts the appropriate video data into data 52 for transmission from the emitter elements of the emitter/detector array and lens system 51. In converting the video data into transmission data 52, the communications control unit 49 encodes the video data with error correction coding and coding to reduce the effects of intersymbol interference and other kinds of well known sources of interference such as the sun and other light sources.

As shown in FIG. 6, the local distribution node 43 also comprises an emitter/detector array and lens system 51, which is arranged (i) to receive the optical beams 53 from the user terminals 47 which are within its field of view and to transmit the received messages 50 to the communications control unit 49 where they are processed and the appropriate action taken; and (ii) to transmit the respective video data 52, via optical beams 53, to the respective user terminals 47.

FIG. 6 also shows the main components of one of the user terminals 47. As shown, the user terminal 47 comprises a user unit 77 which in this embodiment is a television receiver through which the video data is displayed to the user and which includes a user interface (not shown) which allows the user to select one or more video channels for viewing. In response to such a user input, the user unit 77 generates an appropriate message 50 for transmittal to the local distribution node 43. As shown in FIG. 6, this message 50 is output to a laser control unit 79 which controls the laser diode 55 so as to cause the laser beam 57 output from the laser diode 55 to be modulated with the message 50. This output laser beam 57 is then passed through a collimator 59 which reduces the angle of divergence of the laser beam 57. The resulting laser beam 61 is passed through a beam splitter 63 to an optical beam expander 65, which increases the diameter of the laser beam for transmittal to the emitter/detector array and lens system 51 located in the local distribution node 43. The optical beam expander 65 is used because a large diameter laser beam has a smaller divergence than a small diameter laser beam. Additionally, increasing the diameter of the laser beam also has the advantage of spreading the power of the laser beam over a larger area. Therefore, it is possible to use a higher powered laser diode 55 whilst still meeting eye safety requirements. In this embodiment, the user terminals 47 are designed so that they can communicate with the local distribution node 43 within a range of 300 meters with a link availability of 99.9 percent. To achieve this, the laser diode 55 is a 50 mW laser diode which outputs a laser beam having a wavelength of 850 nm.

Using the optical beam expander 65 has the further advantage that it provides a fairly large collecting aperture for the laser beam transmitted by the local distribution node 43 (which carries the video data) and it concentrates this laser beam into a smaller diameter beam. The smaller diameter beam is then split from the path of the originally transmitted laser beam by the beam splitter 63 and focussed onto a photo diode 67 by the lens 69. The electrical signals output by the photo diode 67, which will vary in dependence upon the transmitted data 52, are then amplified by the amplifier 71 and filtered by the filter 73. The filtered signals are then supplied to the clock recovery and data retrieval unit 75 which regenerates the clock and the video data using standard data processing techniques. The retrieved video data 76 is then passed to the user unit 77 where the video data is displayed to the user.

FIG. 7 is a schematic representation of the front surface (i.e. the surface facing the lens system) of the emitter and detector array 80 which is used, in this embodiment, in the emitter/detector array and lens system 51. In this embodiment, the emitter and detector array 80 comprises 8 columns and 8 rows of emitter/detector cells cᵢⱼ (not all of which are shown in the figure). Each emitter/detector cell cᵢⱼ comprises an emitter eᵢⱼ and detector dᵢⱼ located adjacent the corresponding emitter. In this embodiment, the size 81 of the cells cᵢⱼ is between 2 and 40 micrometers, with the spacing (centre to centre) 83 between the cells being slightly greater than the cell size 81. In this embodiment, the emitter elements eᵢⱼ are VCSELs and each of the detectors dᵢⱼ are photodiodes. As those skilled in the art will appreciate, due to the spatial separation of the emitter and detector cells cᵢⱼ, each of the cells can communicate with a different user terminal 47.

In this embodiment, the lens system used in the emitter and detector array and lens system 51 is the same as the lens system shown in FIG. 3 and is arranged so that the spot size of a focussed laser beam from one of the user terminals 47 is slightly greater than the size 81 of one of the emitter/detector cells cᵢⱼ, as illustrated by the shaded circle 85 shown in FIG. 7 which covers the emitter/detector cell c₂₂.

In this embodiment, before a user terminal 47 can communicate with the local distribution node 43, an initialisation procedure is performed. A brief description of this initialization procedure will now be given. On installation of a new user terminal 47, the installer will manually align the user terminal 47, so that the laser beam output by the user terminal will be directed roughly in the direction of the local distribution node 43. The installer will then set the new user terminal 47 into an installation mode in which it outputs a laser beam having a wide beamwidth and carrying an initialisation code to the local distribution node 43. Part of this wide beamwidth laser beam will be received at the local distribution node 43 and will be focussed onto an unknown emitter/detector cell cᵢⱼ by the lens system. The communications control unit 49 then samples signals from all the unassigned cells (i.e. those not already associated with a user terminal 47) until it finds the initialisation code and then assigns that cell to the new user terminal 47 for all future communications. The local distribution node 43 then transmits an optical signal, including an initialisation code, back to the new user terminal 47 using the assigned cell. The new user terminal 47 then uses the strength of the optical signal transmitted by the local distribution node 43 to control servo motors (not shown) to make fine adjustments to the direction in which it transmits optical signals to and receives optical signals from the local distribution node 43. After the initialisation has been completed, the new user terminal is set into its operational mode for receiving the appropriate transmission data 52.

In the above embodiment, a combined emitter and detector array 80 was used. As those skilled in the art will appreciate and as shown in FIG. 8, the array of emitters 87 can be provided separately from the array of detectors 89 by placing a beam splitter 91 between the lens system 95 and the array of emitters 87. Additionally, as represented by the dashed line 93, a lens may also be provided between the beam splitter 91 and the array of detectors 89 if the two arrays have a different size.

In the above embodiments, a simplex and a duplex data distribution system have been described in which each user terminal can communicate with a single local distribution node. FIG. 9 schematically shows a data distribution system which is similar to the system shown in FIG. 1, except that some of the user terminals 103 (such as user terminal U'ₘ) can receive data from more than one local distribution node 99. Such a data distribution system provides the user terminals 103 with a constant uninterrupted communication link even if the line of sight link with one of the local distributions nodes 99 becomes blocked. The general structure of the local distribution nodes 99 and the user terminals 103 is the same as in the first embodiment described with reference to FIG. 2.

FIG. 10 schematically illustrates the emitter array 27 and lens system 105 which is used in this embodiment as part of the local distribution node 99. Corresponding reference numerals to those of preceding figures are used where appropriate for corresponding elements. As shown in FIG. 10, the same wide angled lens 29 is used in the lens system 105 (to give the local distribution node 99 a wide field of view) and the same VCSEL emitter array 27 is used. The only difference between the local distribution node 99 of this embodiment and the local distribution node of the first embodiment is that the convex lens 31 used in the first embodiment has been replaced with a telecentric lens 111 which comprises a stop member 107 having a central aperture 109, which is optically located on the front focal plane 110 of the lens system.

As shown in FIG. 10, the emitter array 27 is optically located on the back focal plane 113 of the lens system 105. In this embodiment, a telecentric lens 111 is used, since this allows the collection efficiency (of light from the emitter array 27) of the lens to be constant across the emitter array 27. Therefore, provided all the emitters are the same, the intensity of the light output from the local distribution node will be the same for each emitter. Whereas, with a conventional lens the intensity of the light output from the local distribution node will be greater for light emitted by emitters in the centre of the array than for those at the edge. The use of a telecentric lens 11 also avoids the various cosine fall-off factors which are well known in conventional lenses. As shown in FIG. 10, light emitted from different elements in the emitter array 27 (represented by the diverging beams 115 and 117) is collected by the telecentric lens and converted into collimated laser beams 119 and 121 respectively which are transmitted to the corresponding user terminal (not shown).

FIG. 11 schematically illustrates the lens system 123 and detector array 125 which forms part of the user terminal 103 and which replaces the lens 14 and photo diode 15 of FIG. 2. As shown, the lens system 123 comprises a wide angle lens 127 (such as a fish eye lens) which maximises the field of view of the user terminal 103 and a convex lens 129 for focussing light received from different local distribution nodes 99 (represented by light rays 131 and 133) onto a respective detector element of the detector array 125. FIG. 12 is a schematic diagram of the front surface (i.e. the surface facing the lens system 123) of the detector array 125 which, in this embodiment, comprises 100 columns and 10 rows of photo diode cells dᵢⱼ, not all of which are shown in the figure. The size 135 and spacing (centre to centre) 137 of the detector cells dᵢⱼ are similar to those of the arrays described earlier. As illustrated by the shaded circle 139 shown in FIG. 12, in this embodiment, the focussing lens 129 is designed so that the spot size of a focussed laser beam from one of the local distribution nodes 99 is slightly greater than the size 135 of one of the detector cells dᵢⱼ.

As those skilled in the art will appreciate and as mentioned above, one of the advantages of this embodiment is that if one of the laser beams (131 or 133) from one of the local distribution nodes 99 is blocked, then the user terminal 103 will still receive the data from the other beam. Another advantage of this embodiment is that since both sides of the free space communications link use wide angled lenses, their field of views are relatively large. Therefore, successful communications can still be carried out even if the user terminal 103 moves relative to the local distribution node 99, provided both remain within the other's field of view. Another advantage of this embodiment is that if the user terminals 103 do move relative to the local distribution nodes 99, then they can determine either when they are about to move out of the field of view of one of the local distribution nodes 99 or when one of the local distribution nodes 99 is about to move out of their field of view. This is possible because as the user terminals 103 move, the laser beams from the local distribution nodes 99 move over the respective detector array 125, and the user terminals 103 can detect this by sampling the signals from the detector cells in their arrays. In such an embodiment, if the user terminal 103 determines that the laser beam from one of the local distribution nodes 99 is about to move off the side of the detector array 125 and if the user terminal 103 is not receiving data from another local distribution node 99, then the user terminal 103 may be configured so as to warn the user that connection to the central distribution system 97 is about to be lost.

A simplex communications system was described above in which an emitter array was provided in each of the local distribution nodes and a detector array was provided in each of the user terminals. As those skilled in the art will appreciate, and as shown in FIG. 13, the communication system shown in FIG. 9 can be made into a duplex communication system by providing an emitter and detector array 51 (such as the array shown in FIG. 7) in both the local distribution nodes 43 and the user terminals 47. Preferably, in such an embodiment, each side of the communications link would use a wide angled telecentric lens such as the one shown in FIG. 10, for the reasons mentioned above. As those skilled in the art will appreciate, in such an embodiment, where the user terminals 47 move relative to the distribution nodes 43 (or vice versa), either side of the communication link can track the movement of the other side within its field of view by tracking the focussed laser beam from the other side as it moves over its emitter/detector array 51. This information can then be used to control the emitter and detector cell which is used in the communications link.

In the duplex communication system described above, both the local distribution nodes and the user terminals comprise an array of emitters. FIG. 14 illustrates the form of a local distribution node 43 and a user terminal 47 according to another embodiment which allows duplex data communications and which has similar advantages to the embodiment described above. As shown in FIG. 14, in this embodiment, the emitter and detector array 51 in the local distribution node has been replaced by a retroreflector and modem unit 141 such as the one disclosed in the applicant's earlier international application WO98/35328, the contents of which are incorporated herein by reference.

In operation, as represented by the double-headed arrows, the retro-reflector and modem unit 141 is operable to receive and modulate light beams 53 from a plurality of user terminals 47 and to reflect the modulated beams 53 back to the respective user terminals 47. As those skilled in the art will appreciate, the reflected laser beams 53 may each be modulated with the same data or with different data, depending upon the application.

FIG. 15 schematically illustrates the retro-reflector and modem unit 141 which is used in this embodiment. As shown, in this embodiment, the retro-reflector and modem unit 141 comprises a wide angle telecentric lens system 149 and an array of modulators and demodulators 147. In this embodiment, the telecentric lens 149 comprises lens elements 157 and 160 and a stop member 151, having a central aperture 153, which is optically located on the front focal plane 155 of lens 157. The size of the aperture 153 is a design choice and depends upon the particular requirements of the installation. In particular, a small aperture 153 results in most of the light from the sources being blocked (which results in a significant transmission loss) but does not require a large expensive lens to focus the light. In contrast, a large aperture will allow most of the light from the sources to pass through but requires a larger and hence more expensive lens system 149. However, since the overriding issue with free space optical transmission is atmospheric loss, little is often gained by increasing the size of the aperture beyond a certain amount.

Due to the telecentricity of the telecentric lens 149, the light incident on the lens is focussed on the back focal plane 159 in such a way that the principal rays 161 and 163 which emerge from the lens system 149 are perpendicular to the back focal plane 159. One problem with existing optical modulators is that the efficiency of the modulation, i.e. the modulation depth, depends upon the angle with which the laser beam hits the modulator. Therefore, if a telecentric lens is not used then, the modulation depth of a received laser beam will depend upon the position of the user terminal 47 which generated the beam within the retro-reflectors field of view. In contrast, by using a telecentric lens 149 and by placing the modulator and demodulator array 147 at the back focal plane 159 of the telecentric lens 149, the principal rays of the laser beams from all the user terminals 47 will be at 90° to the surface of the modulators, regardless of their position within the retro-reflector's field of view. Consequently, a high efficiency modulation will be achieved.

FIG. 16 is a schematic representation of the front surface (i.e. the surface facing the lens system 149) of the modulator and demodulator array 147 which, in this embodiment, comprises 100 columns and 10 rows of modulator/demodulator cells (not all of which are shown in the figure). Each modulator/demodulator cell cᵢⱼ comprises a modulator mᵢⱼ and a demodulator dᵢⱼ located adjacent the corresponding modulator. In this embodiment, the size 169 of the cells cᵢⱼ is between 50 micrometers and 200 micrometers and the spacing (centre to centre) 171 between the cells is slightly greater than the cell size 169. As illustrated by the shaded circle 173 shown in FIG. 16 which covers the modulator/demodulator cell c₂₂, the telecentric lens 157 is designed so that the spot size of a focussed laser beam from one of the user terminals 47 is slightly greater than the size 141 of one of the modulator/demodulator cells cᵢⱼ.

In this embodiment, Quantum Confined Stark Effect (QCSE, sometimes also referred to as Self Electro-optic Devices or SEEDs) modulators developed by the American Telephone and Telegraph Company (AT&T), are used for the modulators mᵢⱼ. FIG. 17a schematically illustrates the cross-section of such a QCSE modulator 175. As shown, the QCSE modulator 175 comprises a transparent window 177 through which the laser beam 53 from the appropriate user terminal 47 can pass, a layer 179 of Gallium Arsenide (GaAs) based material for modulating the laser beam 53, an insulating layer 181, a substrate 183 and a pair of electrodes 185 and 187 located on either side of the modulating layer 179 for applying a DC bias voltage to the material 179.

In operation, the laser beam 53 from the user terminal 47 passes through the window 177 into the modulating layer 179. Depending upon the DC bias voltage applied to the electrodes 185 and 187, the laser beam 53 is either reflected by the modulating layer 179 or it is absorbed by it. In particular, when no DC bias is applied to the electrodes 185 and 187, as illustrated in FIG. 17a, the laser beam 53 passes through the window 177 and is absorbed by the modulating layer 151. Consequently, when there is no DC bias voltage applied to the electrodes 185 and 187, no light is reflected back to the corresponding user terminal 47. On the other hand, when a DC bias voltage of approximately 20 volts is applied across the electrodes 185 and 187, as illustrated in FIG. 17b, the laser beam 53 from the corresponding user terminal 47 passes through the window 177 and is reflected by the modulating layer 179 back upon itself along the same path back to the corresponding user terminal 47.

Therefore, by changing the bias voltage applied to the electrodes 185 and 187 in accordance with the modulation data 52 to be transmitted to the user terminal 47, the QCSE modulator 175 will amplitude modulate the received laser beam 53 and reflect the modulated beam back to the user terminal 47. In particular, as illustrated in FIG. 18, for a binary zero to be transmitted, a zero voltage bias is applied to the electrodes 185 and 187, resulting in no reflected light, and for a binary one to be transmitted a DC bias voltage of 20 volts is applied across the electrodes 185 and 187, resulting in the laser beam 53 being reflected back from the seed modulator 175 to the corresponding user terminal 47. Therefore, the light beam which is reflected back to the user terminal 47 is, in effect, being switched on and off in accordance with the modulation data 52. Therefore, by monitoring the amplitude of the signal output to the amplifier by the emitter/detector array 145 shown in FIG. 14, the corresponding user terminal 47 can detect and recover the modulation data 52 and hence the corresponding video data.

Ideally, the light which is incident on the QCSE modulator 175 is either totally absorbed therein or totally reflected thereby. In practice, however, the QCSE modulator 175 will reflect typically 5% of the laser beam 53 when no DC bias is applied to the electrodes 185 and 187 and between 20% and 30% of the laser beam 53 when the DC bias is applied to the electrodes 185 and 187. Therefore, in practice, there will only be a difference of about 15% to 25% in the amount of light which is directed onto the emitter/detector array 145 when a binary zero is being transmitted and when a binary 1 is being transmitted.

By using the QCSE modulators 175, modulation rates of the individual modulator cells mᵢⱼ as high as 10 Giga bits per second can be achieved. This is more than enough to be able to transmit the video data for the desired channel or channels to the user terminal 47 together with the appropriate error correcting coding and other coding which may be employed to facilitate the recovery of the data clock.

In the above embodiment, each of the local distribution nodes included a retro-reflector and modem unit and the user terminals each included an array of emitters and detectors. FIG. 19 illustrates the form of a local distribution node 43 and a user terminal 47 according to another embodiment which allows duplex data communications between the local distribution node 43 and the user terminals and which has similar advantages to the embodiment described above. As shown in FIG. 19, in this embodiment, a retro-reflector and modem unit 141 is provided in each of the user terminals 47 and an emitter and detector array and lens system 51 is provided in each of the local distribution nodes 43.

The operation of this embodiment is similar to the operation of the previous embodiment except that in this embodiment, each of the user terminals 47 is operable (i) to receive optical beams 53 from one or more local distribution nodes 43; (ii) to detect messages carried by those light beams 53 and to transmit these messages as data 191 to the user unit 189; (iii) to modulate the received light beams in accordance with data 193 received from the user unit; and (iv) to reflect the modulated beams back to the respective local distribution nodes 43. The reflected laser beam 53 carrying the data is then detected by the emitter and detector array and lens system 51 of the local distribution node 43 which is operable to retrieve and pass the data 50 to the communications control unit 49 for onward transmission via the optical fibre link 45.

The advantage of the last two embodiments over the retro-reflecting systems described in the applicant's earlier International application mentioned above is that the “laser-end” of the communications system has the ability to steer its collimated laser beam rapidly and without the need for moving parts (e.g. mirrors), by selecting the emitter in the array of emitters which is used for the communications. This means that accurate physical alignment between the laser end and the reflecting end of the link is not essential. The alignment can be performed “electro-optically” by selecting the emitter to use for the communications. This also allows the system to support communication links between mobile and fixed communication devices or between two or more mobile communication devices.

Examples of where this type of retro-reflecting embodiment (as well as the other embodiments described above) may be used include an office local area network in which fixed network nodes communicate with semi-mobile units attached to personal computers or peripherals. Mobility is required in such a system so that equipment can be moved without the need to realign the equipment with the network nodes. In this application, each mobile node can preferably communicate with more than one fixed network node so that problems of beam obscuration is eased. Another application of these embodiments is to provide communication links between mobile television cameras for, for example, outside broadcast applications. In this case, a meshed network between a number of mobile cameras and a number of fixed stations may be required to ensure true mobility and to overcome obscuration. With this application, the retro-reflecting system described with reference to FIG. 19 would preferably be used with each of the cameras being the “user terminals” with the retro-reflecting modulators because the power consumption of the cameras with this configuration will be less since they do not have to power an array of light emitters. In this embodiment, since the camera is sending the same information to all of the fixed stations, either all of the modulators may be driven in parallel or a single modulator element may be used rather than a pixellated modulator. This considerably simplifies the routing of the drive signals to the modulator pixels.

### MODIFICATIONS

In the retro-reflecting embodiments described above, an array of QCSE modulators was used in the retro-reflecting end of the communication link. These QCSE modulators either absorb or reflect incident light. As those skilled in the art will appreciate, other types of reflectors and modulators can be used. For example, a plane mirror may be used as the reflector and a transmissive modulator (such as a liquid crystal) may be provided between the lens and the mirror. Alternatively still, beam splitters may be used to temporarily separate the path of the incoming beam from the path of the reflected beam and, in this case, the modulator may be provided in the path of the reflected beam so that only the reflected light is modulated. However, such an embodiment is not preferred since it requires additional optical components to split the forward and return paths and to then re-combine the paths after modulation has been effected.

In the above retro-reflecting embodiments, a duplex communication link was provided between the user terminals and the local distribution nodes. As those skilled in the art will appreciate, these retro-reflecting embodiments can be simplified so that the communication link is only a simplex link in which data is transmitted from the local distribution node to the user terminal only (or vice versa).

In the retro-reflecting embodiments described above, a pixellated modulator, i.e. an array of modulators, was employed to modulate the light from the different sources. In an alternative embodiment, a single modulator could be used. In such an embodiment, each of the laser ends of the communication links would receive either the same information or different channels could be provided for the respective sources by time division multiplexing the modulation which is applied to the modulator. However, this type of single modulator is not preferred because the modulator must be relatively large and large modulators are difficult to produce and for some applications cannot be modulated quickly enough to provide the desired data rate.

In the embodiments which employ a telecentric lens, the array of emitters or detectors or modulators are located substantially at the back focal plane of the telecentric lens. As those skilled in the art will appreciate, the telecentric lens can be adapted to have a back focal plane which is curved or partially curved. In this case the array of emitters or detectors or modulators should also be curved or partially curved to match the back focal plane of the telecentric lens.

In the above embodiments, point-to-multipoint, multipoint-to-point and multipoint-to-multipoint signalling systems have been described which employ a multilayer hierarchy. As those skilled in the art will appreciate, the present invention can be applied between two signalling devices, both of which may be fixed or mobile.

In the embodiments described above which employ an array of VCSEL emitters, the light generated by each of the emitters is modulated with the data to be transmitted to the other end of the communication link. The easiest way to modulate the light from the VCSEL emitters is to switch the emitters on and off to thereby amplitude modulate the light emitted from them. However, as those skilled in the art will appreciate, other modulation techniques, such as frequency or phase modulation may be used.

In the above embodiments which employ a collimating lens or a telecentric lens, the laser beam emitted from each emitter will have a divergence caused by diffraction at the exit pupil of the lens. This divergence is therefore minimised by employing as large an exit pupil as possible. As those skilled in the art will appreciate, the use of such diffraction limited sources minimises the divergence in the transmitted optical beams which therefore maximises the range over which successful communications can be made.

In the above embodiments, arrays of VCSEL emitters were used. As those skilled in the art will appreciate, other types of light emitters such as laser diodes and light emitting diodes may be used. The array of emitters could also be formed by a bundle of optical fibres, closely packed into a regular array with a laser diode coupled to the other end of each fibre. However, the use of such bundles of optical fibres or the use of 2D arrays of laser diodes results in a greater beam divergence caused by diffraction at the emitting aperture which is of the order of ±20°. This requires a low f/number (approximately f/1.5) collimating lens to be used if the light is to be efficiently collected and collimated. This increases the cost and complexity of the lens system. However, if the array also has a relatively low packing density (i.e. a low number of light emitters per unit area), then due to large non-emitting areas between the fibres or lasers, the numerical aperture of the beam emitted by each fibre or diode can be reduced by using a small lens close to the emitter. Each lens would increase the effective size of the emitter whilst reducing the divergence. A two-dimensional array of such lenses may be fabricated so as to be spatially matched to the emitter array. Such lenses reduce the numerical aperture of the emitter array and allow a less expensive, higher f/number collimating lens to be employed.

In the above embodiment, two-dimensional arrays of light emitters or light detectors or light modulators were provided. As those skilled in the art will appreciate, it is not essential to have the emitters, detectors or modulators in such a regular array to achieve the advantages given above.

1. An optical device comprising:
a plurality of light emitters each operable to emit a respective light beam; and
a lens system for collecting light emitted from said plurality of light emitters and for directing the light collected from each of the plurality of light emitters in a respective direction within the field of view of the lens system,
characterised in that said lens system comprises a telecentric lens, and in that the plurality of light emitters are optically located substantially at a focal plane of said telecentric lens.

2. An optical device according to claim 1, wherein the telecentric lens comprises:
a lens having a front and a back focal plane; and
a stop member located substantially at said front focal plane,
wherein the plurality of light emitters are located substantially at said back focal plane of said lens and said stop member is operable to block part of the light received from the plurality of light emitters.

3. An optical device according to claim 1 or 2, wherein the telecentric lens has an at least partially curved focal plane, and the plurality of light emitters are located substantially at said at least partially curved focal plane.

4. An optical device according to any preceding claim, wherein the telecentric lens is a wide angled telecentric lens.

5. An optical device according to any preceding claim, wherein the lens system is operable to substantially collimate the light emitted from each of the plurality of light emitters.

6. An optical device according to any preceding claim, wherein the plurality of light emitters are arranged in a regular array.

7. An optical device according to claim 6, wherein the plurality of light emitters are arranged in a two-dimensional array.

8. An optical device according to any preceding claim, wherein one or more of said plurality of light emitters comprises a vertical cavity surface emitting laser.

9. An optical device according to any of claims 1 to 7, wherein one or more of said plurality of light emitters comprises a laser diode.

10. An optical device according to any of claims 1 to 7, wherein one or more said plurality of light emitters comprises a light source and an optical fibre, with the light source being located at one end of the optical fibre and the other end of the optical fibre acting as the light emitter.

11. An optical device according to any preceding claim, further comprising:
means for receiving information; and
control means for controlling each of said light emitters so that the light emitted by the emitters carries said received information.

12. An optical device according to claim 11, wherein the control means is operable to control each of said plurality of emitters individually so that the plurality of emitters are operable to emit respective light beams carrying different information.

13. An optical device according to either claim 11 or 12, wherein the control means is operable to control each of the light emitters by modulating the amplitude, phase or frequency of the emitted light.

14. An optical device according to any preceding claim, further comprising selecting means for selecting one of said plurality of light emitters to be used to emit a light beam.

15. An optical device according to any preceding claim, wherein the signalling device further comprises a plurality of light detectors each for receiving light collected by said lens system from a respective direction within its field of view and for converting the received light into corresponding electrical signals.

16. An optical device according to claim 15, wherein the plurality of light detectors are arranged in a regular array.

17. An optical device according to claim 16, wherein the plurality of light detectors are arranged in a two-dimensional array.

18. An optical device according to any of claims 15 to 17, wherein each light detector comprises a photodiode.

19. An optical device according to any of claims 15 to 18, wherein each light emitter is associated with a respective one of the plurality of light detectors such that an associated light emitter and light detector pair are substantially optically co-located relative to the lens system.

20. An optical device according to claim 19, wherein an associated light emitter and light detector pair are located adjacent to each other.

21. An optical device according to claim 19, wherein the plurality of light emitters and the plurality of light detectors are located separately from each other, and wherein a beam splitter is provided between the plurality of emitters and the plurality of detectors and said lens system in order to optically co-locate the associated light emitter and light detector pair.

22. An optical device according to any of claims 15 to 21 when dependent upon claim 14, wherein the signalling device further comprises tracking means for tracking a light beam received via the lens system as it moves over said plurality of light detectors, and wherein said selecting means is operable to select the light emitter used to emit a light beam in dependence upon an output from said tracking means.

23. An optical device according to claim 22, wherein said tracking means is operable to track said light beam by monitoring the level of electrical signals output by said plurality of light detectors.

24. A signalling system comprising first and second signalling devices,
wherein the first signalling device comprises an optical device according to any preceding claim, wherein each of the plurality of emitters of the first signalling device is operable to emit a respective light beam carrying information; and
wherein the second signalling device comprises: i) a lens system for collecting light emitted from a light emitter of said first signalling device; ii) a light detector for receiving the collected light from said lens system and for converting the received light into corresponding electrical signals; and iii) means for processing the electrical signals from said light detector to retrieve said information.

25. A signalling system according to claim 24, wherein said lens system of the second signalling device is operable to focus the light collected from the light emitter of said first signalling device onto said light detector.

26. A signalling system according to either claim 24 or 25, wherein said light detector of the second signalling device comprises a photodiode.

27. A signalling system according to any of claims 24 to 26, wherein said light detector of the second signalling device comprises a plurality of light detectors for receiving light collected by said lens system of the second signalling device from respective different directions within its field of view, and for converting the received light into corresponding electrical signals.

28. A signalling system according to claim 27, wherein said plurality of light detectors in said second signalling device are arranged in a regular array.

29. A signalling system according to claim 28, wherein said plurality of light detectors in said second signalling device are arranged in a two-dimensional array.

30. A signalling system according to any of claims 24 to 29, wherein the lens system of the second signalling device comprises a wide angled lens.

31. A signalling system according to any of claims 24 to 29,
wherein said second signalling device further comprises a light emitter for emitting a light beam carrying information,
wherein the lens system of the second signalling device is operable to collect the light emitted from said light emitter of the second signalling device and to direct the light towards the first signalling device,
wherein the lens system of the first signalling device is operable to collect the light emitted from the light emitter of said second signalling device, and
wherein said first signalling device further comprises: i) a light detector for detecting light received by the first signalling device and for converting the received light into a corresponding electrical signal; and ii) means for processing the electrical signal from said light detector to retrieve the information carried by the light beam emitted by said second signalling device.

32. A signalling system according to any of claims 24 to 30,
wherein said second signalling device further comprises a plurality of light emitters each for emitting a respective light beam carrying information,
wherein the lens system of the second signalling device is operable to collect the light emitted from said plurality of light emitters of the second signalling device and to direct the light beams in respective directions within its field of view,
wherein the lens system of the first signalling device is operable to collect light emitted from a light emitter of said second signalling device, and
wherein said first signalling device further comprises i) a light detector for receiving the collected light from said lens system and for converting the received light into a corresponding electrical signal; and ii) means for processing the electrical signal from said light detector to retrieve said information carried by the received light beam emitted from said second signalling device.

33. A signalling system according to claim 32, wherein the plurality of light emitters of said second signalling device are arranged in a regular array.

34. A signalling system according to claim 33, wherein said plurality of light emitters of the second signalling device are arranged in a two-dimensional array.

35. A signalling system according to any of claims 32 to 34 when dependent upon claim 27, wherein each of the plurality of light emitters of the second signalling device is associated with a respective one of the plurality of light detectors of the second signalling device, such that an associated light emitter and light detector pair are substantially optically co-located relative to the lens system of the second signalling device.

36. A signalling system according to claim 35, wherein an associated light emitter and light detector pair of the second signalling device are located adjacent to each other.

37. A signalling system according to claim 35, wherein the plurality of light emitters of the second signalling device and the plurality of light detectors of the second signalling device are located separately from each other, and wherein a beam splitter is provided between the plurality of emitters and the plurality of detectors and said lens system of the second signalling device in order to optically co-locate the associated light emitter and light detector pairs of the second signalling device.

38. A signalling system according to any of claims 32 to 34, wherein said lens system of the second signalling device comprises a telecentric lens, and wherein the plurality of light emitters are optically located substantially at a focal plane of said telecentric lens.

39. A signalling system according to claim 38 wherein the telecentric lens of the lens system of the second signalling device comprises:
a lens having a front and a back focal plane; and
a stop member located substantially at said front focal plane,
wherein the plurality of light emitters of the second signalling device are optically located substantially at said back focal plane of said lens and said stop member is operable to block part of the light received from the plurality of light emitters.

40. A signalling system according to any of claims 24 to 39 when dependent upon claim 22, wherein said tracking means of said first signalling device is operable to track a light beam received from the second signalling device as it moves over said plurality of light detectors of the first signalling device with relative movement between the first and second signalling devices, and wherein said selecting means of the first signalling device is operable to select the light emitter used to transmit to the second signalling device in dependence upon an output from said tracking means.

41. A signal system according to claim 32 or any claim dependent thereon, wherein said second signalling device further comprises selecting means for selecting a light emitter to be used to emit light back to said first signalling device.

42. A signalling system according to claim 41 when dependent upon claim 27, wherein said second signalling device further comprises means for tracking a light beam received from the first signalling device as it moves over said plurality of light detectors of said second signalling device with relative movement between the first and second signalling devices, and wherein said selecting means is operable to select a light emitter to be used to transmit a light beam back to said first signalling device.

43. A signalling system according to claim 40 or 42, wherein said tracking means is operable to track said light beams by monitoring the level of the electrical signals output by said plurality of light detectors.

44. A signalling system according to any of claims 24 to 43, comprising a plurality of first signalling devices, each arranged to emit light from a respective light emitter to one or more second signalling devices.

45. A signalling system according to any of claims 24 to 43, comprising a plurality of second signalling devices each arranged to receive light from a respective light emitter of said first signalling device.

46. A signalling system comprising first and second signalling devices, wherein:
the first signalling device comprises an optical device according to any of claims 1 to 23; and
and the second signalling device comprises: i) a lens system for collecting light emitted from a light emitter of the signalling device of said first signalling device; ii) a light reflector for reflecting the collected light from said lens system back to the first signalling device through the lens system; and iii) a modulator for modulating the light collected by said lens system and/or the reflected light with modulation data for the first signalling device,
wherein the first signalling device further comprises a light detector for detecting modulated light received by the first signalling device and for converting the received light into corresponding electrical signals, and means for processing the electrical signals from said light detector to retrieve the modulation data.

47. A signalling system according to claim 46, wherein said lens system of the second signalling device is operable to focus the light collected from the light emitter of said first signalling device onto said light reflector.

48. A signalling system according to claim 46 or 47, wherein said reflector comprises a retro-reflector.

49. A signalling system according to any of claims 46 to 48, wherein said reflector comprises a mirror.

50. A signalling system according to any of claims 46 to 49, wherein said reflector is curved or partially curved to match the focal plane of the lens system of said second signalling device.

51. A signalling system according to any of claims 46 to 50, wherein said modulator is operable to modulate at least one of the amplitude, phase, frequency and polarisation of the received signals.

52. A signalling system according to any of claims 46 to 51, wherein said modulator is transmissive and is located between said lens system and said reflector.

53. A signalling system according to claim 52, wherein said modulator comprises a liquid crystal modulator.

54. A signalling system according to any of claims 46 to 51, wherein said modulator and said reflector are formed as a single unit.

55. A signalling system according to claim 54, wherein said combined modulator and reflector comprises a quantum confined Stark effect device.

56. A signalling system according to any of claims 46 to 55, wherein the lens system of the second signalling device comprises a wide angled lens.

57. A signalling system according to any of claims 46 to 56, wherein said second signalling device comprises a plurality of light reflectors each for receiving light collected by the lens system of the second signalling device from a respective direction within its field of view and for reflecting the light back in the respective direction.

58. A signalling system according to claim 57, wherein the plurality of light reflectors of said second signalling device are arranged in a regular array.

59. A signalling system according to claim 58, wherein the plurality of light reflectors of said second signalling device are arranged in a two-dimensional array.

60. A signalling system according to any of claims 46 to 59, wherein said second signalling device further comprises: (i) a light detector for receiving a portion of the collected light from the lens system of the second signalling device and for converting the received light into corresponding electrical signals; and (ii) means for processing the electrical signals from the light detector to retrieve information carried on the light beam emitted from said first signalling device.

61. A signalling system according to claim 60, wherein said light detector of the second signalling device comprises a plurality of light detectors each for receiving light collected by said lens system of the second signalling device from respective different directions within its field of view and for converting the received light into corresponding electrical signals.

62. A signalling system according to claim 61, wherein said plurality of light detectors in said second signalling device are arranged in a regular array.

63. A signalling system according to claim 62, wherein said plurality of light detectors in said second signalling device are arranged in a two-dimensional array.

64. A signalling system according to claim 61 when dependent upon claim 57, wherein each light reflector of said second signalling device is associated with a respective one of the light detectors in the second signalling device, such that an associated light reflector and light detector pair are substantially optically co-located relative to the lens system of the second signalling device.

65. A signalling system according to claim 64, wherein an associated light reflector and light detector pair are located adjacent to each other.

66. A signalling system according to any of claims 46 to 65, wherein said lens system of the second signalling device comprises a telecentric lens, and wherein the light reflector is located substantially at a focal plane of said telecentric lens.

67. A signalling system according to any of claims 46 to 66, wherein said lens system of the second signalling device comprises a lens having a front and back focal plane, wherein a stop member is located substantially at the front focal plane for blocking part of the light received from the first signalling device and wherein said light reflector is optically located substantially at the back focal plane of said lens.

68. A signalling system according to any of claims 46 to 67, wherein the modulator comprises a plurality of modulator elements each for modulating light collected by the lens system of the second signalling device from a respective direction within its field of view.

69. A signalling system according to any of claims 46 to 68, wherein said second signalling device comprises control means for controlling said modulator so that the light reflected back to the first signalling device carries said information.

70. A signalling system according to claim 69 when dependent upon claim 68, wherein said control means is operable to control each of said plurality of modulator elements individually so that each reflected light beam can carry different information.

71. A signalling system according to claim 70, wherein said second signalling device further comprises selecting means for selecting a modulator element to be used to modulate light to be reflected back to said first signalling device.

72. A signalling system according to 71 when dependent on claim 61, wherein the second signalling device further comprises means for tracking a light beam received via the lens system of the second signalling device as it moves over the plurality of light detectors of the second signalling device with relative movement between the first and second signalling devices, and the selecting means is operable to select the modulator element used to modulate light to be reflected back to the first signalling device in dependence upon an output of the tracking means of the second signalling device.

73. A signalling system according to any of claims 46 to 72, comprising a plurality of first signalling devices each arranged to emit light from a respective light emitter to said second signalling device and to receive a respective modulated light beam back from the second signalling device.

74. A signalling system according to any of claims 46 to 73, comprising a plurality of second signalling devices each arranged to receive light from a respective light emitter of the first signalling device and to reflect the light modulated with data back to the first signalling device.

75. A signalling system according to any of claims 24 to 74, wherein said first and second signalling devices are relatively moveable.

76. A signalling kit comprising one or more first signalling devices, each first signalling device comprising an optical device as claimed in any of claims 1 to 23, and a plurality of second signalling devices, each comprising: i) a lens for collecting light emitted from a light emitter of a first signalling device; ii) a light detector for receiving the collected light from the lens system and for converting the received light into corresponding electrical signals; and iii) means for processing the electrical signals from the light detector to retrieve information carried by the collected light.

77. An office communication network comprising a signalling system according to any of claims 24 to 76.

78. A television system comprising a signalling system according to any of claims 24 to 76.

79. A signalling method using first and second signalling devices, the method comprising the steps of:
at the first signalling device: i) optically locating a plurality of light emitters substantially at a focal plane of a telecentric lens system; ii) emitting light carrying information from at least one light emitter from said plurality of light emitters; and iii) collecting light emitted from the at least one light emitter using the telecentric lens system and directing the light in a respective direction within the field of view of the telecentric lens system; and
at the second signalling device: i) collecting light emitted from the light emitter of the first signalling device using a lens; ii) receiving the collected light on a light detector and converting the received light into corresponding electrical signals; and iii) processing the electrical signals from the light detector to retrieve the information.

80. A signalling method using first and second signalling devices, the method comprising the steps of:
at the first signalling device: i) optically locating a plurality of light emitters substantially at a focal plane of a telecentric lens system; ii) using at least one light emitter from said plurality of light emitters to emit light carrying information; iii) collecting the light emitted by the at least one light emitter using the telecentric lens system and directing the collected light in a respective direction within the field of view of the telecentric lens system;
at the second signalling device: i) using a lens to collect the light emitted from the at least one light emitter of the first signalling device; ii) reflecting the collected light from the lens back to the first signalling device through the lens; and iii) modulating the light collected by the lens system and/or the reflected light with modulation data for the first signalling device; and
at the first signalling device: iv) collecting the modulated light beam which is reflected back from the second signalling device using the telecentric lens system; v) receiving the collected modulated light on a light detector and converting the received light into corresponding electrical signals; and vi) processing the electrical signals from the light detector to retrieve the modulation data.
